(19) United States
(12) Patent Application Publication
(10) Pub. No.: US 2020/0372474 A1
(43) Pub. Date: Nov. 26, 2020

(54) Time Clock

(71) Applicant: Jose Friman, West Palm Beach, FL (US)

(72) Inventor: Jose Friman, West Palm Beach, FL (US)

(21) Appl. No.: 16/830,309

(22) Filed: Mar. 26, 2020

Related U.S. Application Data
(60) Provisional application No. 62/853,035, filed on May 26, 2019.

(51) Int. Cl. G06Q 10/10; G06Q 10/06

(52) U.S. Cl. CPC G06Q 10/1091; G06Q 10/06398

(57) ABSTRACT

The present invention discloses a system and method for improvement in general process of online time management for employees. The system provides the method to accurately monitor employees as between the various offices locations and/or departments or working from home. The system also provides the remote access of employees work screen by linking the administrator with remote location employee.

### BACKGROUND

### Field of the Invention

The invention relates to an online management and attendance system for monitoring of employees working within office or at remote locations.

### Description of the Related Art

Effective operation of any business, corporation and/or Government agency, requires an accurate means of recording employee's attendance and hours worked so that an effective payroll system may be maintained. This, of course, is in addition to the use of such records to determine vacation schedules, efficiency and productivity studies and use in other ways in corporate management and operation.

The maintenance of such records usually involves the employee punching a time slip into a time clock upon entering and leaving the working establishment. These time slips would in turn be used by a timekeeper to determine the attendance and hours worked. While such an arrangement may be effectively utilized in a small business, in a large corporation or Government agency, i.e., such as the Post Office, the use of manual time cards involves numerous procedures for handling, which are often complex and lead to mistakes by timekeepers, aside from the time lost due to constant monitoring, auditing and management attention to insure procedures are being followed. Often times, employees are shifted on a temporary basis to understaff locations or departments and then shifted back, which is somewhat disrupting to a centralized system. In addition, monitoring and/or regulating overtime is somewhat at a disadvantage since manual record keeping is not usually capable of being maintained on an instantaneous basis.

For example, the U.S. Post Office has approximately 645,000 employees working at 31,000 installations and is subject to the Fair Labor Standards Act which requires great accuracy in attendance and time records. Recognizing the inefficiencies of the manual time cards, the Post Office is presently attempting to fully automate their system in this regard. Partial automatization has been accomplished by way of the Postal Source Data System, described in Fiscal Handbook F22 published by the U.S. Postal Service with information of some employees being fed directly into on-line data centers. The remaining employees still utilize manual time cards, with manual procedures as described in Fiscal Handbook F21 published by the U.S. Postal Service.

Similarly an Employee time entry and accounting system bearing U.S. Pat. No. 5,717,867A is issued to Mirage Resorts Inc. The invention discloses a time entry and accounting system permitting employees to clock in and clock out from work at computerized time clocks located adjacent to their workstations using an individually encoded identification card. The time clock is configured to have a normally closed state and an opened state and to move between states in response to a supervisor scanning his identification card. The computerized time clocks are interactively linked to a central computer and, upon an employee clocking in or out, the central computer receives appropriate signals from the time clock, and stores information corresponding to these signals in memory. The information stored in the memory of the computer is subsequently used to develop accounting records and reports, to generate payroll data, and to send signals to the time clocks. The time clock further includes a display screen permitting the time clock to display messages in response to signals sent by the central computer and a plurality of buttons permitting an employee or supervisor to send additional information to the central computer.

A time management system for mobile employees bearing US patent 2,005,002,1428A1 is issued to Charles Costello. The patent discloses a time management system for mobile employees is a telecommunications system allowing a company client to manage their off-site employees efficiently and effectively. Mobile employees, in communication with the system Web server via a cell phone or PDA, enter time transaction data using the mobile computing device's Web browser. Based upon the employee's predefined profile, custom Web pages are presented requesting employee specific time transaction information. Once received, time transaction data may be forwarded to the company client's computer directly or downloaded to client computers upon request or based upon a predetermined schedule. Having at least one Web server and application/database server, the system maintains employee data, client data, project data, and transaction data. The system protects against unauthorized access of data by having defined administrative user privileges.

A system for working at a remote office PBX bearing U.S. Pat. No. 6,950,507B1 is issued to Shoretel Inc. The patent discloses an arrangement that includes at least two PBXs interconnected by a network employs CTI ports to control operation of the PBXs. Through such control, a user can set up a telephonic presence in a visited PBX such that, to the user and to all others who interact with the user, it appears that the user is at the user's office, rather than at an office that is served by the visited PBX. This is effected by forwarding calls that are destined to the user at the user's office to the visited PBX, and by translating all dialing commands of the user at the visited PBX, and acting upon the translated commands, so as to provide the user with the features available to the user at the user's office while presenting an appearance to called parties that the user is at the user's office.

An automated time and attendance system bearing U.S. Pat. No. 4,323,771A is issued to Oliver H. Chalker, Jr., Robert J. Spooner. The patent discloses an automated employee time and attendance system having a central processor and a plurality of sub-systems which are capable of providing data used by the central processor in payroll determination. Each sub-system is capable of maintaining clocking information along with other employee data, adjusting such data and retrieving such data in a printed form when so desired by a timekeeper. A means is provided for allowing the monitoring of loaned and borrowed employees as between the sub-systems so that payroll determination in their regard is accurately maintained. Periodically data stored in the subsystems are conveyed to the central processor where it sorts and merges all data received from the sub-systems including the clocking data whereby accurate payroll determination is affected.

A remote time and attendance system and method bearing US patent 2,008,011,468,3A1 is issued to NEVEU HOLDINGS LLC. The patent discloses a system and method for remote time collection are provided. Generally, various embodiments of the invention provide users with a system and method for tracking employee time and/or confirming job site arrival remotely. In accordance with various embodiments, a system and method for remote time collection comprises a variety of devices and components, such as a local client, a local server, a wireless communication system, and a remote computing device. An exemplary remote computing device comprises a biometric system and a GPS system for verifying that the correct employee is working at the correct job site.

An office attendance management system bearing Japanese patent JPH09115021A is issued to Japanese inventor Hiroyuki Terashita. The patent focuses on a problem to grasp the office attendance state of employees without any trouble for transcription, calculation, etc., by inputting office leaving data, day-off date, etc., corresponding to an employee's code and recording them in the memory of a terminal, and transmitting the recorded data to a management personal computer and totalizing the data. It presents a solution of an employee makes the card reader 2a, provided for the terminal 2, read the employee's code recorded on the employee card 3 when coming to and leaving his or her office and inputs the office attendance and leaving data, day-off data, etc., corresponding to the employee's code, so that the data are recorded in the memory of the terminal 2. The data recorded on the terminal 2 are transmitted to the management personal computer 1 connected by a communication line and the management personal computer 1 totalizes those data to manage the office attendance state of employees. Consequently, the office attendance state of the employees can be grasped without any trouble for transcription, calculation, etc.

An employee based on face recognition method and system for remote attendance bearing Canadian patent 1,046,16364B is issued to a Chinese inventor. The patent discloses remote attendance of employees based on face recognition method, comprising: a basic information input employee attendance of employees and disposed face attendance equipment and can allow time attendance thereon; arbitrary choice employees attendance a face attendance and sending a command to capture the face of the face of the staff attendance equipment face acquisition; face and facial features pictures facial attendance equipment will be collected sent to the server; server to send additional personnel command, basic information of employees, face images and facial features sent to the appropriate face time and attendance equipment; if employees work or travel to an office attendance, local people face attendance equipment will collect the employee's face image and people locally stored facial feature face image and the facial feature matching, to determine whether the employees in attendance on the face attendance devices. The invention optimizes existing time and attendance management processes, time and attendance Management Company saves manpower and time.

A personal Office Attendance Management System bearing Canadian patent CN1,088,30561A is issued Chinese inventor. The present invention discloses a kind of personal office attendance management system, comprising: a personal office module, file management module and the common resource sharing module, a personal office module and file management module and the module is connected to the common resource sharing, according to personal office module including mail receiving module statistics, daily trip planning module, and meeting attendance module module, the file management modules including document management module, network drives to archive module and lost new recording module, the module includes a common library resource sharing take reading module, using the module parking spaces, office supplies requisitioned module and employees message reply modules. The system has the employee used to send and receive mail, trip planning, meetings and embodied in a document management system, easy to use, readily accessible, on the organization of work will not cause omission.

An intelligence attendance office chair bearing Canadian patent CN2,050,06385U is issued to Chinese inventor. The patent discloses a utility model relates to an intelligence attendance office chair who has the attendance function. Including attendance machine 1, office chair 2 the lower part installation attendance machine 1 of the arbitrary handrail in 2 two handrails of office chair 3 4 positions in the seat face of office chair 2 set up sensor 5, prompting device 6, be equipped with central processing unit 7 in the attendance machine 1, the fingerprint identification ware 8 the surface of attendance machine 1 is equipped with display panel 9, sensor 5, prompting device 6 are connected with central processing unit 7. The utility model discloses replace public fingerprint attendance machine, convenient and fast with intelligence attendance office chair, the actual time on the station of staff can also be added up, attendance efficiency is improved.

There are multiple solutions that have been presented in prior art. However, these solutions are limited and restricted to their conventional architecture and system. This invention relates to a novel and useful concept of an application that is proposed to be compatible for all types of employees. Whether an employee is hourly based or full time or working at remote locations, the proposed invention presents an online time management for employees who can clock in and out. The system will also monitor what they are doing once they are clocked in. The system will also provide video streaming with auto once they are clocked in and administrator can also view the screen of employees.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The objective of the invention is to provide a system for maintain employee attendance record and online evaluation of their work.

It is also the objective of the system to provide a system and architecture to solve the technical problem and to provide an off-site employee based on face recognition attendance method.

Accordingly it is an object of the invention to provide for an automated time and attendance system which is practical, reliable and eliminates the time lost in manual time card handling and recording.

A yet further object is to provide for a system which will allow for the maintenance of records and incorporation into the system of sick time, vacation time, overtime and other time categories in the system and a means for continuous updating and editing at the individual offices and/or installations.

According to another aspect of the invention, the architecture presents an online monitoring of employee screen activities especially in case of employees working from remote locations or work from home setup.

Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to a system and procedure for online Time Management for employees. Employees as per preferred embodiment of the invention can record their time in and time out. The system will record and maintain the log of employees, their work hours and this data can be utilized further in payroll management.

The system as per its additional embodiment allows the administrator or owner of the system to monitor the activities of employees by live video streaming. This allows the chance of performance evaluation of employees especially who are working from are off locations or work from home.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I: A method of time and attendance system for accumulating and processing information about a plurality of employees in a workplace having workstations where employees perform assigned tasks under the supervision. The system provides the capability of online monitoring and performance evaluation of employees whether at work desks, remote locations or are performing work from home.

II: A central computer electronically linked to the time clock and receiving the data signals from the time clock wherein the employees can punch in their information regarding entry and exit from the office premises.
A uniqueness of our method is going to be viewing the employee, they will have a camera on their PC and our system can see them along with what they are doing.
